(19) United States
(12) Patent Application Publication
(10) Pub. No.: US 2009/0283946 A1
(43) Pub. Date: Nov. 19, 2009

(54) SINGLE-SIDED MAGNETIC FIXTURING SYSTEMS

(75) Inventors: Wayne W. Cai, Troy, MI (US); Chi-Hung Shen, Troy, MI (US)

Correspondence Address: CICHOSZ & CICHOSZ, PLLC, 129 E. COMMERCE, MILFORD, MI, 48381, US

(73) Assignee: GM GLOBAL TECHNOLOGY OPERATIONS, INC., DETROIT, MI (US)

(21) Appl. No.: 12/123,236

(22) Filed: May 19, 2008

(51) Int. Cl. B25B 11/00

(52) U.S. Cl. 269/8

(57) ABSTRACT

A combination useful for providing a clamping force to a workpiece during a manufacturing operation so as to maintain a workpiece in a stationary position includes a workpiece having a first side and a second side, a magnet disposed about a portion of the first side of the workpiece, and a pressure pad disposed about a portion of the second side of the workpiece. The pressure pad may include one or more of permanently magnetic materials and ferromagnetic materials, and disposed in sufficient proximity with respect to the magnet to enable the pressure pad to be attracted by the magnet, thus providing a clamping force on the workpiece.

### TECHNICAL FIELD

This disclosure relates generally to fixtures useful in manufacturing. More particularly, it relates to combinations, systems, and methods useful for maintaining a workpiece in a stationary position during a manufacturing operation using the forces of magnetism.

### BACKGROUND

During manufacturing operations wherein a workpiece comprising a raw stock material or a partially-finished intermediate component is desired to be worked upon, which may include altering the shape of the workpiece, cutting portions away from, sculpting, or adding other features or components thereto such as by welding, it is often desirable to maintain such a workpiece in a stable position while one or more manufacturing or fabrication steps are undertaken with respect to the workpiece. Methods are known for maintaining a workpiece in a stable position during an operation. Some examples include: saw horses, vises, clamps, and tables having a range of configurations and features. However, given the wide variety of articles desirably worked upon during manufacturing, no single particular method for holding a workpiece in a stable position is in general universally applicable to all forms of manufacturing.

### SUMMARY

A combination useful for providing a clamping force to a workpiece during a manufacturing operation so as to maintain a workpiece in a stationary position includes a workpiece having a first side and a second side, a magnet disposed about a portion of the first side of the workpiece, and a pressure pad disposed about a portion of the second side of the workpiece. The pressure pad may include one or more of permanently magnetic materials and ferromagnetic materials, and disposed in sufficient proximity with respect to the magnet to enable the pressure pad to be attracted by the magnet, thus providing a clamping force on the workpiece.

### BRIEF DESCRIPTION OF THE DRAWINGS

One or more embodiments will now be described, by way of example, with reference to the accompanying drawings, in which:

FIG. 1 shows a side perspective view of a schematic diagram of a known fixturing system;

FIG. 2 shows a perspective view of a schematic diagram of a fixturing system according to one embodiment of the instant disclosure;

FIGS. 3A, 3B, 3C, and 3D depict cross-sectional views of various mechanisms for clamping a workpiece in accordance with the present disclosure; and

FIGS. 4A and 4B depict cross-sectional views of various mechanisms for clamping a workpiece in accordance with alternate embodiments of the present disclosure.

### DETAILED DESCRIPTION

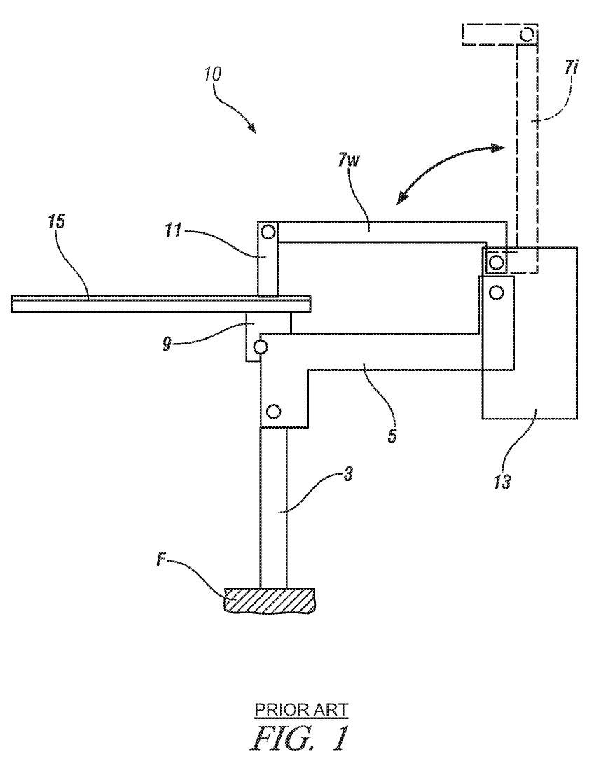

Referring now to the drawings, wherein the showings are for the purpose of illustrating certain exemplary embodiments only and not for the purpose of limiting the same, FIG. 1 shows a side perspective view of a schematic diagram of a fixturing system arrangement 10 according to the prior art. The cooperative clamping of a workpiece 15, effected by a clamping force developed between an L-block 9 that is disposed on a support blade 5, and a pressure pad 11 which is attached to a clamp arm 7w oriented in its working position. Often, such a support blade 5 comprises a first end portion and a second end portion, and is maintained in a fixed position with respect to a floor F in a work area as shown by means of its first end portion being rigidly affixed to a stationary riser 3 having an upper end and a lowermost end, which riser 3 in the simplest sense may be a vertical beam having its lowermost end attached to the floor F by conventional fasteners, or by its being embedded in concrete. To the second end portion of the support blade 5 is attached a power source 13, which may typically be an electric solenoid, a pneumatic actuator, or a hydraulic actuator. The power source 13 has a clamp arm moveably attached to it, which is capable of selectively controlling the position of the clamp arm between that of an idle position 7i shown in FIG. 1 as the dashed line, and the working position shown in FIG. 1 as 7w, the motion between the idle and working positions generally following the direction of the double-headed arrow shown attendant successive cyclings during a manufacturing operation. By such an arrangement, a portion of a workpiece 15 disposed on the L-block 9 when the clamp arm is in its idle position at 7i, may be firmly clamped and held in fixed position by virtue of the clamp arm being controllably moved from its idle position at 7i to its working position at 7w, making it then possible to carry out various fabrication techniques on the workpiece 15 so held. In this sense, the L-block 9 and pressure pad 11 can be thought of as collectively comprising a cooperative clamping pair. Often, manufacturing shops employ fixtures which comprise a plurality of such arrangements 10 described above for clamping a single workpiece 15; however, such arrangements as described generally require a large workspace to operate, and provided added operational safety considerations associated with the movement of a plurality of the swinging portions of the cooperative clamping pairs. Further, these systems require relatively large amounts of hardware, including power sources 13 which add to routine maintenance schedule requirements.

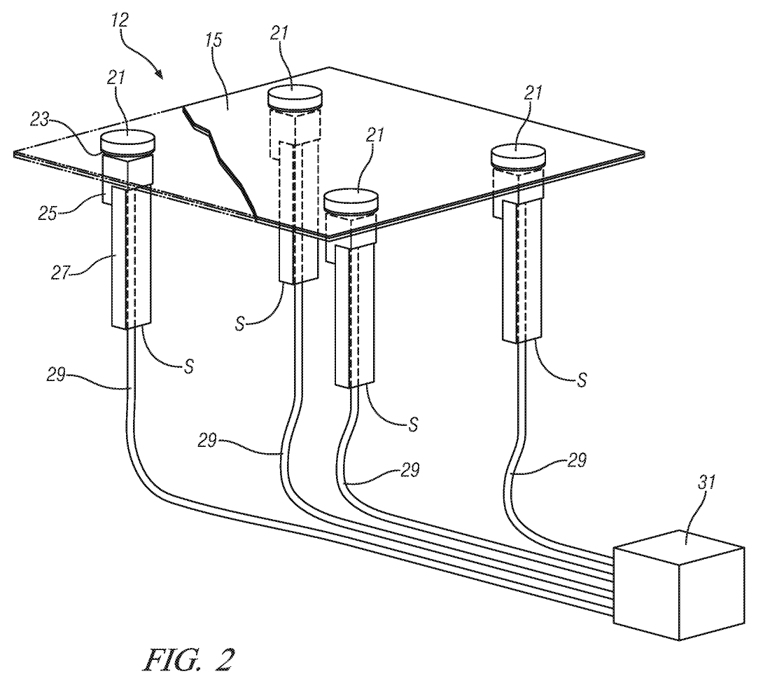

FIG. 2 is a perspective view of a schematic diagram of a fixturing system 12 according to one embodiment of the instant disclosure. In FIG. 2, the respective locations of a cooperative clamping pair which comprises a clamping pad 21 and a magnet 25 are shown. Generally speaking, a clamping pad 21 provided by several embodiments of this disclosure are free-standing and not affixed to any equipment, machinery or apparatus when not in use. The magnet 25 may exist in any geometric shape desired, but is generally dependent on the shape of the workpiece 15 that is desired to be held in a fixed position by the cooperative clamping pair, or a plurality of cooperative clamping pairs, for a given manufacturing operation. An L-shaped block may be employed as the magnet 25. Alternatively, any shape of a block may be used, provided the magnet 25 contacts it and provided the block is comprised of a ferromagnetic material, because in such instance the magnet 25 will cause temporary magnetization of the block, thus rendering it to function as a magnet itself. For purposes of this specification and the claims appended hereto, a material is ferromagnetic if it has a magnetic permeability of at least about 50 Newtons per ampere squared (N/A²). A workpiece 15 may be any article that is capable of being clamped between a cooperative clamping pair and typically includes articles such as automotive body panels including doors, hoods, trunk covers, engine compartment covers, auto and truck frames; however, the use of combinations and systems as herein described is not limited to such articles but is generally applicable to manufacturing in other industries including without limitation, earthmoving equipment, aircraft, shipbuilding, woodworking, and robotics. Generally, a workpiece has a first side and a second side, and the first side is disposed so it is facing the magnet(s) 25 and in sufficient proximity therewith so that when a pressure pad(s) 21 is disposed in proximity to the second side of the workpiece, attractive forces cause the pressure pad(s) 21 to be attracted to the magnet 25, thus providing a clamping force on the workpiece. In one embodiment, the magnet 25 is an electromagnet. In another embodiment, the magnet 25 is a permanent magnet which may comprise magnets of any and all known types, including without limitation AlNiCo magnets, ceramic magnets, rare earth magnets, and magnetized metals and alloys thereof selected from the group consisting of: iron, cobalt, nickel, and samarium. For all embodiments in which a permanent magnet or particles of a permanently magnetic material are specified in this disclosure, any permanent magnetic material may be used, including compounds, alloys, mixtures and the like which include Fe, Co, and Ni either alone or in combination with one another or other rare earth elements (which may include niobium and samarium), as are known to those having ordinary skill in the art. In one embodiment, the magnet 25 is affixed to the first end portion of a riser 27, with the second end portion of the riser 27 being affixed to a substrate S by conventional means, or affixed to essentially any stationary object. Suitable substrates include floors, walls, ceilings, booms, extension arms, frameworks, robots, and other machines used in a fabrication or manufacturing processes. In alternate embodiments, the riser(s) 27 may be affixed, directly or indirectly, to a wheeled base for ease in portability. One advantage of a fixturing system 12 provided by this disclosure is that it lacks the bulkiness of prior art systems, such as that aforedescribed, which are designed for analogous functions, and is thus more portable. For purposes of illustration but without limitation, FIG. 2 depicts four separate constructs comprising a magnet affixed to a riser. However, generally speaking, any number of such constructs necessary or desired by workmen to maintain a workpiece in a stable position during a manufacturing operation as taught herein may be employed, and may be arranged in any desired or beneficial configuration. This may include also mounting or affixing a construct which comprises a magnet as taught herein to objects other than floors or machines, including without limitation walls, ceilings, booms, and extension arms such as the arm of a robot. FIG. 2 also shows a feature of further alternate embodiments, as will be described in relation to non-ferrous workpieces, where an optional adhesive layer 23 disposed between the pressure pad 21 and the workpiece 15 is used to advantage in clamping the workpiece 15. This disclosure also includes embodiments wherein the workpiece 15 is a multi-layered structure, as well as embodiments in which a plurality of workpieces 15, either free-standing individually, or stacked atop one another are simultaneously maintained in a stationary position according to the disclosure.

For instances in which the magnet 25 is selected to be an electromagnet, electrical cables 29 are provided to convey electrical energy from an electrical power source 31 to the electromagnet. In one embodiment, the flow of electricity from the power source 31, which may comprise direct current, is controlled manually by an operator by means of their throwing a common electrical switch. In other embodiments, the flow of electricity from the power source 31 to any given individual electromagnet is responsively controlled by a microprocessor having provisions for inputting and processing data from location or other prior art sensors present in the area in which the fixturing system 12 is disposed. Solid-state relays and other switching devices or methods known to those skilled in the electrical arts are suitable for effectuating such switching.

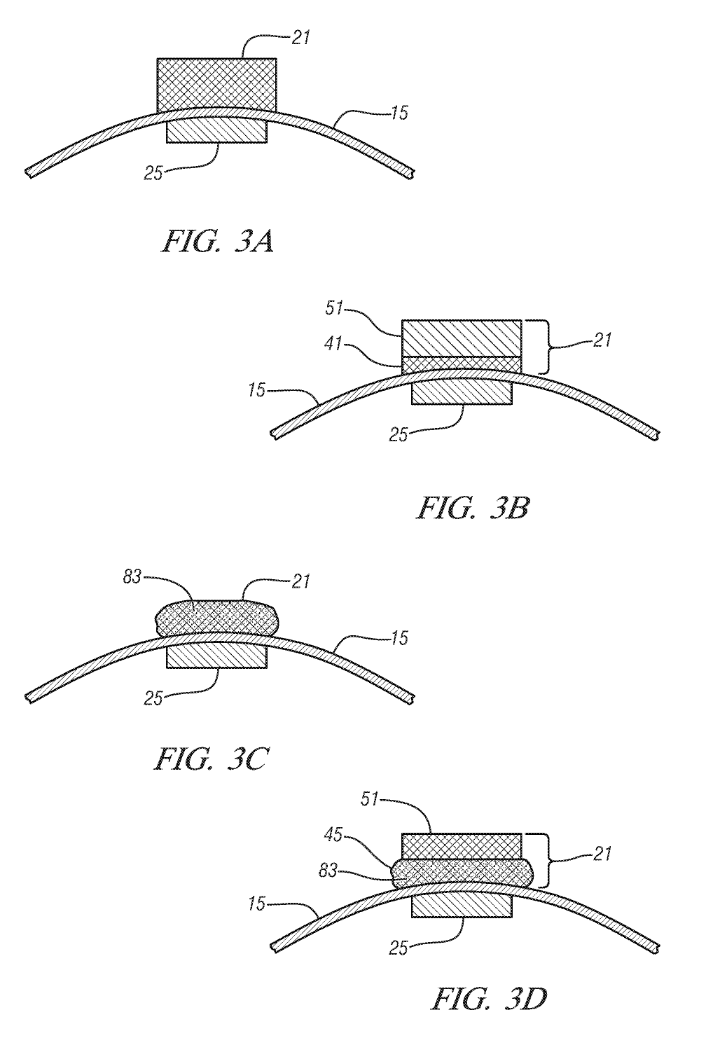

FIG. 3A is a cross-sectional view of a mechanism for clamping a workpiece in accordance with one embodiment of the present disclosure, when the workpiece 15 is comprised of a ferromagnetic material, such as iron, steel, or sheet metal. In this embodiment, pressure pad 21 comprises a permanent magnet, which may be any type of magnet. In one embodiment, the magnet which comprises the pressure pad 21 is contoured so as to have a concave surface which contacts a convex surface feature of workpiece 15, beneath which is disposed magnet 25 that is mounted in any location as previously set forth, and often at or near the end of a riser. The attraction of the magnet which comprises the pressure pad 21 to the magnet 25 provides a clamping force on the workpiece 15. The magnitude of the clamping force developed between the components of a cooperative clamping pair as provided in this disclosure is directly dependent upon the field strength of the magnet 25, and in general is desirably any magnitude of force which is sufficient to maintain a workpiece 15 in a stationary position while the workpiece 15 is being acted or operated on. In one embodiment, the magnitude of such clamping force is generally any force greater than about 0.1 Newtons. In another embodiment, the magnitude of such clamping force provided by a cooperative clamping pair is any force greater than about 1 Newton, the upper limit of which is dictated only by the requirements at hand, namely the mass of the workpiece, its orientation, and the total number of cooperative clamping pairs present which are acting to maintain the workpiece 15 in a stable position, all of which are within the control of the workmen and engineers.

FIG. 3B shows a cross-sectional view of a mechanism for clamping a workpiece in accordance with an alternate embodiment of the present disclosure, when the workpiece 15 is comprised of a ferromagnetic material. In this embodiment, pressure pad 21 is a multi-component pressure pad that comprises a mass 51 of ferromagnetic material, which may be a block of iron or any other ferromagnetic material, that is in contact with a permanent magnet portion 41 which itself is in contact with the workpiece 15. In one embodiment, the permanent magnet portion 41 of the multi-component pressure pad 21 is contoured so as to have a concave surface which contacts a convex surface feature of workpiece 15, beneath which is disposed magnet 25 that is mounted in any location as previously set forth, and often at or near the end of a riser. The attraction of the magnet portion 41 which comprises the multi-component pressure pad 21 to the magnet 25 provides a clamping force on the workpiece 15. In this embodiment, the clamping force is typically stronger than the embodiment shown in FIG. 3A (for a magnet 25 of equivalent magnetic field) owing to the slight magnetization of the mass 51 of ferromagnetic material by the permanent magnet portion 41 and the attraction of magnet 25 for the mass 51 of ferromagnetic material. In embodiments wherein a pressure pad 21 comprises a mass of a ferromagnetic material that is disposed in sufficient proximity to a permanent magnet portion 41 that the permanent magnet exerts an attractive force greater than about 0.01 Newtons on the mass of ferromagnetic material, the magnet and ferromagnetic material, for purposes of this specification and the claims appended hereto, are referred to as being in effective magnetic contact.

FIG. 3C is a cross-sectional view of a mechanism for clamping a workpiece in accordance with an alternate embodiment of the present disclosure, when the workpiece 15 is comprised of a ferromagnetic material. In this embodiment, pressure pad 21 comprises a bag inside of which is contained particles of a pulverized or powdered form of any permanently magnetic material 83. Particle sizes which are suitable for permanently magnetic materials and ferromagnetic materials used according to this disclosure may be any particle size in the range of between about 0.1 millimeters and about 1 centimeter, with a particle size of about 0.5 millimeters being preferred. The bag may be comprised of conventional materials from which such articles are typically made, including without limitation fabrics, both woven and non-woven, made from fibers which can include cotton, linen, flax, cellulosics, synthetic fibers, and any other known fibers. In alternate embodiments the bag may be made from a polymeric material, including without limitation thermoplastic and thermoset materials such as polyolefin homopolymers and copolymers. The main proviso of a bag that is so employed is that its pore size should be smaller than the tiniest of the particles of permanently magnetic material 83 it contains, so as to contain the particles. Multi-layer pouches may be employed, including, to cite but one example, those in which particles of permanently magnetic material 83 are contained in a polyethylene bag, which itself is surrounded by an outer layer of burlap. As in other embodiments described above, the attraction of the permanently magnetic material 83 contained in the bag which comprises the pressure pad 21 to the magnet 25 provides the clamping force on the workpiece 15. Such feature of having permanently magnetic particles 83 contained in a bag enables a pressure pad 21 of such embodiments to be mutable with respect to their outer contour, dependent upon the contour of the workpiece 15 which is contacted, thus providing enhanced clamping forces to the workpiece 15 with simultaneous versatility with respect to the shapes of workpieces which may be so clamped.

FIG. 3D shows a cross-sectional view of a mechanism for clamping a workpiece in accordance with an alternate embodiment of the present disclosure, when the workpiece 15 is comprised of a ferromagnetic material. In this embodiment, pressure pad 21 is a multi-component pressure pad that comprises a mass 51 of ferromagnetic material, which may be a block of iron or other ferromagnetic material, that is in contact with a bag 45, inside of which is contained particles of a pulverized or powdered form of permanently magnetic material 83. The bag may be comprised of materials as described in relation to the embodiment of FIG. 3C subject to the same proviso regarding pore size, and multi-layer pouches may also be employed in embodiments according to this FIG. 3D. Again, the attraction of the permanently magnetic material 83 contained in the bag to the magnet 25 provides the clamping force on the workpiece 15. In this embodiment, the clamping force is typically stronger than the embodiment shown in FIG. 3C (for a magnet 25 of equivalent magnetic field) owing to the slight magnetization of the mass 51 of ferromagnetic material caused by the permanently magnetic material 83 and the attraction of magnet 25 for the mass 51 of ferromagnetic material. Such feature of having particles of permanently magnetic material 83 contained in a bag enables a multi-component pressure pad 21 of such embodiments to be mutable with respect to their outer contour which contacts the workpiece 15, dependent upon the contour of the workpiece 15 which is contacted, thus providing enhanced clamping forces to the workpiece 15 with simultaneous versatility with respect to the shapes of workpieces which may be so clamped. For embodiments in which a pressure pad 21 comprises a mass of a ferromagnetic material that is disposed in sufficient proximity to particles of any permanently magnetic material 83 contained in a bag wherein the particles of permanently magnetic material collectively exert an attractive force greater than about 0.01 Newtons on the mass of ferromagnetic material, the particles of permanently magnetic material and the ferromagnetic material, for purposes of this specification and the claims appended hereto, are referred to as being in effective magnetic contact.

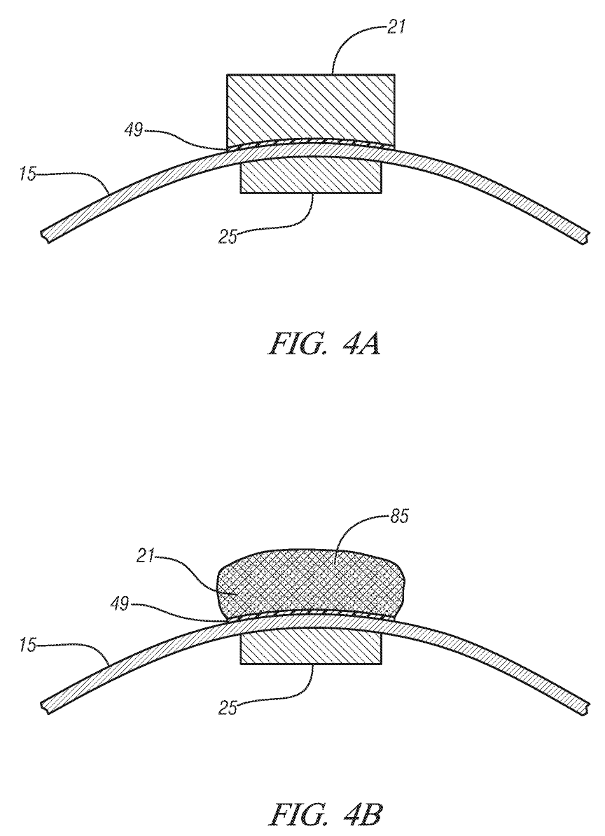

FIG. 4A is a cross-sectional view of a mechanism for clamping a workpiece in accordance with one embodiment of the present disclosure, when the workpiece 15 is non-ferromagnetic, including wood, glass, polymeric materials, fiberglass, and other composite materials. In this embodiment, pressure pad 21 comprises a block of ferromagnetic material, which may be a block of iron, that is initially maintained in contact with the non-ferromagnetic workpiece 15 by means of a layer of an adhesive material 49, which may be any type of adhesive and is preferably one which is readily removable, such as a two-sided adhesive tape. In some embodiments the adhesive comprises an amorphous or atactic polyolefin material or blend thereof having a heat of fusion less than about 30 Joules per gram and a weight-average molecular weight that is less than about 30,000. However, any other known adhesive is suitable provided it is removable from the workpiece 15 after a fabrication operation. In particular embodiments, the adhesive may be free-standing and directly applied to the pressure pad 21 or the workpiece prior to a fabrication process and removed thereafter. In alternate embodiments, the adhesive may be mounted on a carrier, such as a tape, ribbon or the like. Preferably, the adhesive employed is one which has an open-time that is greater than the duration of time that the workpiece 15 is intended to be clamped by a cooperative clamping pair as provided herein. In one embodiment, the pressure pad 21 is contoured, such as by machining, so as to have a concave surface which contacts a convex surface feature of workpiece 15, beneath which is disposed magnet 25 that is mounted in any location as previously set forth, and often at or near the end of a riser. The attraction of the ferromagnetic pressure pad 21 to the magnet 25 provides a clamping force on the non-ferromagnetic workpiece 15.

FIG. 4B shows a cross-sectional view of a mechanism for clamping a workpiece in accordance with an alternate embodiment of the present disclosure, when the workpiece 15 is non-ferromagnetic. In this embodiment, pressure pad 21 comprises a bag inside of which is contained particles of any ferromagnetic material 85. The bag may be comprised of conventional materials from which such articles are typically made, including without limitation fabrics, both woven and non-woven, made from fibers which can include cotton, linen, flax, cellulosics, synthetic fibers, and any other known fibers. In alternate embodiments the bag may be made from a polymeric material, including without limitation thermoplastic and thermoset materials such as polyolefin homopolymers and copolymers. The main proviso of a bag that is so employed is that its pore size should be smaller than the tiniest of the particles of ferromagnetic material 85 it contains, so as to contain the particles. Multi-layer pouches may be employed, including, to cite but one example, those in which particles of ferromagnetic material 85 are contained in a polyethylene bag, which itself is surrounded by an outer layer of burlap. In this embodiment, as in other embodiments described above, the attraction of the ferromagnetic material 85 contained in the bag which comprises the pressure pad 21 to the magnet 25 provides the clamping force on the non-ferromagnetic workpiece 15. Such feature of having particles of ferromagnetic material 85 contained in a bag enables a pressure pad 21 of such embodiments to be mutable with respect to their outer contour, dependent upon the contour of the workpiece 15 to which is contacted, thus providing enhanced clamping forces to the workpiece 15 with simultaneous versatility with respect to the shapes of workpieces which may be so clamped. Since the workpiece 15 is non-ferromagnetic in this embodiment, there is also provided a layer of adhesive 49 disposed between and in contact with both the pressure pad 21 and the workpiece 15. In some embodiments the adhesive comprises an amorphous or atactic polyolefin material or blend thereof having a heat of fusion less than about 30 Joules per gram and a weight-average molecular weight that is less than about 30,000. However, any other known adhesive is suitable provided it is removable from the workpiece 15 after a fabrication operation. In particular embodiments, the adhesive may be free-standing and directly applied to the pressure pad 21 or the workpiece prior to a fabrication process and removed thereafter. In alternate embodiments, the adhesive may be mounted on a carrier, such as a tape, ribbon or the like. Preferably, the adhesive employed is one which has an open-time that is greater than the duration of time that the workpiece 15 is intended to be clamped by a cooperative clamping pair as provided herein.

For embodiments herein which specify permanent magnets or permanently magnetic materials as a component of a combination, the present disclosure also provides like embodiments wherein one or more electromagnets are substituted in the place of one or more of the permanent magnets or permanently magnetic materials. As those having ordinary skill in the art will appreciate after reading this specification and the claims appended hereto, such a substitution will of course include a requirement to provide electrical cables, a switching means which may include ordinary switches or microprocessor-controlled switches, and a power source for such electromagnets. For those instances in which particles of permanently magnetic materials are contained in a bag, the coils of the electromagnets so employed may be contained within the bag itself, or may be disposed on the exterior of the bag, in either instance being attached thereto using conventional means such as by stitching, stapling, adhesives, brackets, with mounts for wound coils in one embodiment being affixed to the bag itself or a framework disposed therein.

Generally, to use a fixturing system according to the disclosure, one first locates the workpiece so that its first side is facing the magnet(s) 25. The pressure pads 21 are then placed onto the workpiece at desired locations before an operation is carried out on the workpiece either manually, or via a robot in an automated process. For cases where the pressure pads comprise a permanent magnet, a magnetic clamping force is developed immediately. For cases where the pressure pad(s) 21 comprise an electromagnet, a magnetic clamping force is developed immediately once an electrical current is provided to the coil of the electromagnet. Following a fabrication or manufacturing operation having been carried out on a workpiece 15, the pressure pad(s) 21 may be removed and the workpiece 15 moved on in a manufacturing queue. By mounting the magnet(s) 25 on a shop jig, fixture, or the like which is provided with several different locations for affixing the magnet(s) 25, an extremely versatile and adjustable fixturing system may be provided.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A combination useful for providing a clamping force to a workpiece during a manufacturing operation so as to maintain said workpiece in a stationary position, said combination comprising:
a workpiece having a first side and a second side;
a magnet disposed about a portion of said first side of said workpiece; and
a pressure pad disposed about a portion of said second side of said workpiece, said pressure pad comprising one or more of permanently magnetic materials and ferromagnetic materials;
wherein said pressure pad is disposed in sufficient proximity with respect to said magnet to enable said pressure pad to be attracted by said magnet, thus providing a clamping force on said workpiece.

2. A combination according to claim 1 wherein said magnet comprises one or more of electromagnets and permanent magnets.

3. A combination according to claim 1 wherein said workpiece comprises a ferromagnetic material.

4. A combination according to claim 1, further comprising:
an adhesive material disposed between and in contact with both of said pressure pad and said workpiece.

5. A combination according to claim 4 wherein said adhesive material comprises a two-sided tape having a front and rear face, with an adhesive disposed on both of said faces.

6. A combination according to claim 4 wherein said workpiece comprises a non-ferromagnetic material.

7. A combination according to claim 1 wherein said magnet is attached to a substrate selected from the group consisting of: a floor, a machine, a wall, a ceiling, a boom, an extension arm, a framework, and a robot.

8. A combination according to claim 1 wherein said pressure pad comprises a permanently magnetic material and further comprising a solid mass of a ferromagnetic substance in effective magnetic contact with a portion of said permanently magnetic material that is not in contact with said workpiece.

9. A combination according to claim 1 wherein said pressure pad comprises particles of a permanently magnetic material disposed in a bag.

10. A combination according to claim 9 further comprising a solid mass of a ferromagnetic substance in effective magnetic contact with a portion of said bag that is not in contact with said workpiece.

11. A combination according to claim 1 wherein said pressure pad comprises a solid mass of a ferromagnetic material and wherein an adhesive is disposed between said pressure pad and said workpiece.

12. A combination according to claim 1 wherein said pressure pad comprises particles of a ferromagnetic material disposed in a bag, and wherein an adhesive is disposed between said pressure pad and said workpiece.

13. A system for maintaining a workpiece in a stationary position, which system comprises a plurality of magnet/pressure pad clamping combinations as specified in claim 1, all operating on a single workpiece to maintain the workpiece in a stable position.

14. A system according to claim 13 wherein the magnets in said combinations comprise electromagnets, and further comprising:
a source of direct current electricity;
electrical conductors disposed between said source of direct current electricity and at least one of said electromagnets sufficient to provide an electrical circuit;
a microprocessor; and
at least one microprocessor-controlled switch signally coupled to said microprocessor and present in said electrical circuit, said at least one switch being disposed between said source of direct current electricity and one or more of said electromagnets.

15. A process for holding a workpiece that is to be subject to a manufacturing operation in a stable position comprising:
providing a workpiece having a first side and a second side;
providing a magnet disposed about a portion of the first side of the workpiece; and
providing a pressure pad disposed about a portion of the second side of the workpiece, said pressure pad comprising one or more of permanently magnetic materials and ferromagnetic materials;
wherein said pressure pad is caused to be disposed in sufficient proximity with respect to said magnet to enable the pressure pad to be attracted by the magnet sufficiently to provide an effective amount of clamping force on said workpiece for preventing substantial movement of said workpiece.

16. A process according to claim 15 further comprising:
removing said pressure pad from said workpiece.

17. A process according to claim 15 wherein said magnet comprises one or more of electromagnets and permanent magnets.

18. A process according to claim 15 wherein said pressure pad comprises a permanently magnetic material in a form of one or more of particles of a permanently magnetic material disposed in a bag, and a solid mass of a permanently magnetic material.

19. A process according to claim 15 wherein said pressure pad comprises a ferromagnetic material in a form of one or more of particles of a ferromagnetic material disposed in a bag, and a solid mass of a ferromagnetic material.

20. A process according to claim 19 wherein said pressure pad has an outer surface which comprises a layer of an adhesive material disposed thereon.
